(19) United States
(12) Patent Application Publication
(10) Pub. No.: US 2020/0382207 A1
(43) Pub. Date: Dec. 3, 2020

(54) Method And Apparatus For Hybrid Automatic Repeat Request Design In Non-Terrestrial Network Communications

(71) Applicant: MediaTek Singapore Pte. Ltd., Singapore (SG)

(72) Inventors: Abdelkader Medles, Cambridge (GB); Gilles Charbit, Cambridge (GB)

(21) Appl. No.: 16/884,570

(22) Filed: May 27, 2020

Related U.S. Application Data
(60) Provisional application No. 62/853,777, filed on May 29, 2019.

(51) Int. Cl. H04B 7/185; H04L 1/18; H04W 8/24; H04W 72/04

(52) U.S. Cl. CPC H04B 7/18532; H04L 1/1819; H04L 1/1845; H04W 72/042; H04W 8/24

(57) ABSTRACT

Various solutions for hybrid automatic repeat request (HARQ) design in non-terrestrial network (NTN) communications with respect to user equipment and network apparatus in mobile communications are described. An apparatus may determine a maximum number of HARQ processes that the apparatus can support. The apparatus may transmit a capability report to indicate the maximum number of HARQ processes. The apparatus may perform HARQ process transmissions based on the maximum number of HARQ processes.

### CROSS REFERENCE TO RELATED PATENT APPLICATION(S)

The present disclosure is part of a non-provisional application claiming the priority benefit of U.S. Patent Application No. 62/853,777, filed on 29 May 2019, the content of which being incorporated by reference in its entirety.

### TECHNICAL FIELD

The present disclosure is generally related to mobile communications and, more particularly, to hybrid automatic repeat request (HARQ) design in non-terrestrial network (NTN) communications with respect to user equipment and network apparatus in mobile communications.

### BACKGROUND

Unless otherwise indicated herein, approaches described in this section are not prior art to the claims listed below and are not admitted as prior art by inclusion in this section.

A non-terrestrial network (NTN) refers to a network, or a segment of network(s), using radio frequency (RF) resources on board a satellite or an unmanned aircraft system (UAS) platform. A typical scenario of an NTN providing access to a user equipment (UE) involves either NTN transparent payload, with the satellite or UAS platform acting as a relay, or NTN regenerative payload, with a base station (e.g., gNB) on board the satellite or UAS platform.

In Long-Term Evolution (LTE) or New Radio (NR), hybrid automatic repeat request (HARQ) procedure is introduced to improve transmission reliability. The user equipment (UE) needs to report HARQ-acknowledgement (HARQ-ACK) information for corresponding downlink transmissions in a HARQ-ACK codebook. The HARQ procedure may involve a plurality of HARQ processes (e.g., 8 HARQ processes). Each downlink transmission may associate with one HARQ process identifier (ID). The HARQ process ID is used to identify a unique HARQ process. The same HARQ process ID can be used to identify a re-transmission of data. This can enable the UE to make use of the repeated transmission for soft combining. To perform soft combining, incorrectly received coded data blocks are often stored at the receiver (e.g., stored in the soft buffer) rather than discarded, and when the re-transmitted block is received, the two blocks are combined. The soft buffer may be implemented as buffers or memories for storing the soft combining data.

In NTN communications, the long propagation delay is expected and leads to very long HARQ round trip time (RTT_{HARQ}). The HARQ RTT is time interval between initial transmission and retransmission. If the HARQ RTT increases, the quality of service (QoS) requirement of the retransmitted packet would not be satisfied by increased end-to-end latency. Thus, these very long HARQ RTT times in NTN communications lead to an increase in the minimum number of required HARQ processes. This represent a challenge since the NR terrestrial network only allows for 16 HARQ processes. Increasing the number of HARQ processes may lead to higher soft buffer requirements leading to higher UE implementation complexity and cost.

Accordingly, for the long HARQ round trip time in NTN communications, how to design/support HARQ processes without increasing the soft buffer of the UE becomes an important issue in the newly developed wireless communication network. Therefore, there is a need to provide proper schemes to perform HARQ process transmissions without increasing UE implementation complexity and cost.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to HARQ design in NTN communications with respect to user equipment and network apparatus in mobile communications.

In one aspect, a method may involve an apparatus determining a maximum number of HARQ processes that the apparatus can support. The method may also involve the apparatus transmitting a capability report to indicate the maximum number of HARQ processes. The method may further involve the apparatus performing HARQ process transmissions based on the maximum number of HARQ processes.

In one aspect, a method may involve an apparatus receiving a capability report from a UE. The method may also involve the apparatus determining a maximum number of HARQ processes that the UE can support according to the capability report. The method may further involve the apparatus performing HARQ process transmissions based on the maximum number of HARQ processes.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT) and Industrial Internet of Things (IIoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example table showing RTT requirements for different communication distances.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to HARQ design in NTN communications with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

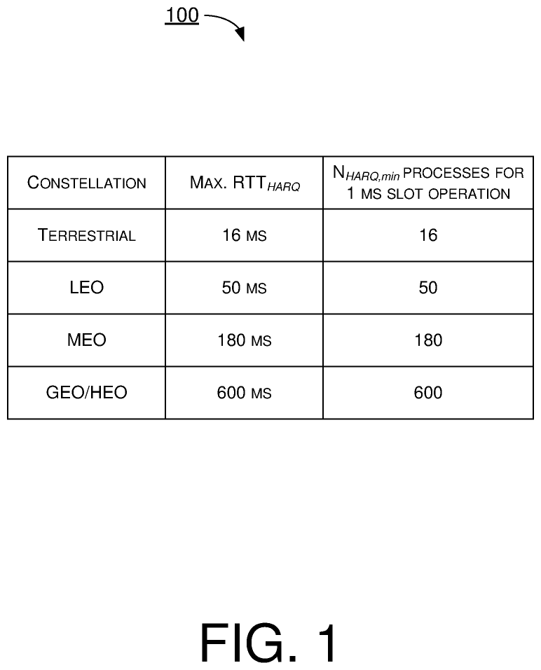

In NTN communications, the long propagation delay is expected and leads to very long HARQ round trip time (RTT_{HARQ}). The HARQ RTT is time interval between initial transmission and retransmission. FIG. 1 illustrates an example table 100 showing RTT requirements for different communication distances. For terrestrial communications, the maximum RTT_{HARQ} may be 16 milliseconds (ms), and the minimum number of HARQ processes (N_{HARQ,min}) required for 1 ms slot operation may be 16. For low earth orbit (LEO) communications, the maximum RTT_{HARQ} may be 50 ms, and the N_{HARQ,min} required for 1 ms slot operation may be 50. For medium earth orbit (MEO) communications, the maximum RTT_{HARQ} may be 180 ms, and the N_{HARQ,min} required for 1 ms slot operation may be 180. For geosynchronous equatorial orbit (GEO)/highly elliptical orbit (HEO) communications, the maximum RTT_{HARQ} may be 600 ms, and the N_{HARQ,min} required for 1 ms slot operation may be 600.

If the HARQ RTT increases, the quality of service (QoS) requirement of the retransmitted packet would not be satisfied by increased end-to-end latency. Thus, these very long HARQ RTT times in NTN communications lead to an increase in the minimum number of required HARQ processes. This represent a challenge since the NR terrestrial network only allows for 16 HARQ processes. Increasing the number of HARQ processes may lead to higher soft buffer requirements leading to higher UE implementation complexity and cost. However, different implementations may provide different flexibilities and soft buffer requirement. Some UEs may be able to support a much larger number of HARQ processes than 16. Given that for NTN bandwidth, number of spatial layers and number carrier are smaller than those typically use for NR terrestrial network (NR-TN). The UE may be able to re-use the same NR-TN soft buffer to support a higher number of HARQ processes for NTN without increasing the soft buffer.

In view of the above, the present disclosure proposes a number of schemes pertaining to HARQ design in NTN communications with respect to the UE and the network apparatus. According to the schemes of the present disclosure, the UE may be able to signal a maximum number of HARQ processes it can support without increasing its soft buffer as a capability. Then, the network node may determine the maximum number of HARQ processes it can configure for the UE and perform HARQ transmissions based on the supported maximum number of HARQ processes. On the other hand, the network node may also configure two HARQ process pools to the UE. HARQ process pool 1 may be configured to support soft combining and HARQ process pool 2 may be configured without supporting soft combining. Accordingly, the UE only need to meet the HARQ soft combining performance only for pool 1 and don't need to meet the soft combining performance for pool 2. The complexity, cost and requirements on UE design and implementation may be relaxed and may have more flexibility.

Specifically, the UE may be configured to determine a maximum number of HARQ processes it can support. The UE may determine the maximum number of HARQ processes supported under the condition of using the same soft buffer as NR-TN without increasing the soft buffer. The maximum number of HARQ processes may comprise at least one of the HARQ processes UE can support with soft combining and the HARQ processes UE can support without soft combining. The UE may be configured to transmit a capability report to indicate the maximum number of HARQ processes to a network node of the NTN. Then, the UE may perform HARQ process transmissions based on the maximum number of HARQ processes.

The UE may explicitly signalling the maximum number of HARQ process supported to the network node. For example, the UE may transmit the capability report associated with at least one of a maximum number of resource block (RB), a maximum number of spatial layers, and a maximum number of transport block size (TBS). Alternatively, the UE may implicitly signal its capability in the capability report such as at least one of an unlimited number of HARQ processes, a specified maximum number of HARQ processes, and no increase in the maximum number of HARQ processes at all with respect to NR-TN. The signalling may be restricted to the downlink only or supported for uplink as well.

At the network side, the network node may be configured to receive the capability report from the UE. The network node may determine the maximum number of HARQ processes that the UE can support according to the capability report. For example, the network node may determine the maximum number of HARQ processes according to the explicitly signalling of maximum number of HARQ process supported by the UE. The network node may also determine the maximum number of HARQ processes according to at least one of a maximum number of RB, a maximum number of spatial layers, and a maximum number of TBS. The network node may further determine the maximum number of HARQ processes according to at least one of an unlimited number of HARQ processes, a specified maximum number of HARQ processes, and no increase in the maximum number of HARQ processes at all with respect to NR-TN signaled from the UE. Then, the network node may perform HARQ process transmissions based on the maximum number of HARQ processes.

In some implementations, the network node (e.g., gNB) may assume that the UE can support any number of HARQ processes that does not increase the soft buffer size beyond NR-TN. The network node may also determine the maximum number of HARQ process that the UE can support according to some scaling factors. For example, the network node may derive the maximum number of HARQ process according to a formula of floor (16×(maximum number of RB NR-TN)/(maximum number of RB NTN)×(maximum number of layers NR-TN)/(maximum number of layers NTN)). In another example, the scaling for number carrier components that can be supported for NR-TN/NTN may also be added to the formula. Other scaling such as the one corresponding to the modulation and/or coding rate may as well be added to the formula.

In some implementations, the network node may determine the maximum number of HARQ processes according to a ratio of a maximum number of RB in NR-TN to a maximum number of RB in NR-NTN. The NR-TN maximum number of RB in NR-TN may be, for example, 100 MHz. The available RB for NR-NTN may be limited to 20-30 MHz. The network node may determine the maximum number of HARQ processes according to a ratio of a maximum number of spatial layers in NR-TN to a maximum number of spatial layers in NR-NTN. The maximum number of spatial layers in NR-TN may depend on the UE implementation. The maximum number of spatial layers in NR-NTN may comprise only one spatial layer. The network node may determine the maximum number of HARQ processes according to a scaling of number of carrier components that can be supported in NR-TN and NR-NTN. The network node may determine the maximum number of HARQ processes according to a scaling of modulation and coding rate used in NR-TN and NR-NTN.

On the other hand, the UE may signal whether it supports the scaling of the number of HARQ processes along with details on how to do the scaling. The UE may be configured to transmit an indication to indicate whether a scaling of maximum number of HARQ processes is supported. The indication may be comprised in the capability report. The scaling may be restricted to the downlink only or supported for uplink as well.

In some implementations, the number of HARQ processes for NR-NTN does not increase the soft buffer size requirement beyond the NR-TN soft buffer size. This condition may be based on a reference calculation for the soft buffer size using reference configurations for NR-NTN/NT including, for example and without excluding other parameters, the number of RB, number of layers, constellation, coding rate or overhead.

In some implementations, to support configuration of a number of HARQ processes greater than 16, the network node or the UE may be configured to determine the number of downlink control information (DCI) bits used for signalling HARQ identification (ID) (e.g., uplink or downlink) by a formula of Number_bits=max (4, ceiling (log₂ (number of HARQ processes configured on the link))), where the link may be either downlink or uplink. The network node or the UE may determine the number of DCI bits used to signal the HARQ process ID according to the maximum number of HARQ processes supported.

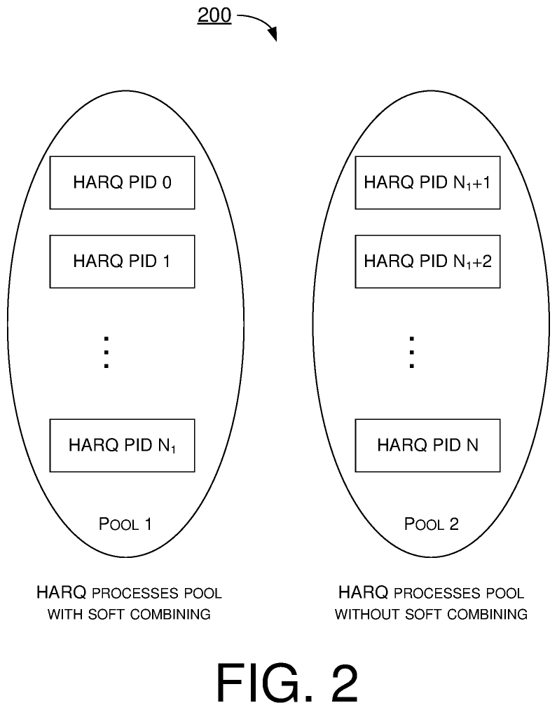

To cover the RTT, the network node may need to configure the UE with a number of HARQ processes more than what the UE can perform soft combining for. The proposal is that the UE may be able to support two kinds of HARQ processes pools. FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network, an NB-IoT network or an IIoT network). The network node may configure a first HARQ process pool (e.g., pool 1) and a second HARQ process pool (e.g., pool 2) to the UE. The UE may be configured to determine the first HARQ process pool and the second HARQ process pool. The first HARQ process pool may comprise HARQ process ID (PID) 0 to N₁ which may be configured for HARQ processes with soft combining requirements. The second HARQ process pool may comprise HARQ process PID N₁+1 to N which may be configured for HARQ processes without soft combining requirements. Then, the network node and/or the UE may perform the HARQ process transmissions with soft combining with respect to the first HARQ process pool and perform the HARQ process transmissions without soft combining with respect to the second HARQ process pool. Accordingly, the UE may need to meet the HARQ soft combining performance only for the first HARQ process pool. The UE may store past soft combined data to perform soft combining with future receptions only for the first HARQ process pool. This is not required for the second HARQ process pool. The UE may still send acknowledgement (ACK)/negative-ACK (NACK) report but it is not required to meet the soft combining performance for the second HARQ process pool.

For the second HARQ process pool, since no soft combining will be performed, the expected redundancy version (RV) that the UE expect to receive may be restricted to ensure that the transmissions/re-transmissions are self-decodable. This may be implemented by a restriction on the redundancy version. For example, either rv0 or rv2 independently of the coding rate may be used for the second HARQ process pool. Alternatively, the UE may expect the combination of the redundancy version and the coding to be self-decodable. Thus, the network node may be restricted to transmit a specific redundancy version of downlink data to the UE with respect to the second HARQ process pool. The UE may expect to receive a specific redundancy version of downlink data with respect to the second HARQ process pool and decode the downlink data based on the specific redundancy version. The specific redundancy version should be self-decodable. In addition, the new data indicator (NDI) may still be used for the second HARQ process pool to differentiate between an initial transmission and a retransmission.

To differentiate between the first HARQ process pool and the second HARQ process pool processes, several approaches may be possible. For example, the network node may transmit an explicit signalling (e.g., an explicit indication) to the UE to differentiate the first HARQ process pool and the second HARQ process pool. The UE may receive the indication to differentiate the first HARQ process pool and the second HARQ process pool. Alternatively, an implicit signalling may be used to differentiate the first HARQ process pool and the second HARQ process pool. The network node may configure a number of HARQ processes which is greater than the maximum number of HARQ processes that the UE can support with soft combining. For example, the network node may configure a number of HARQ processes (e.g., N_HARQ_processes) more than what the UE can support with soft combining (e.g., N1_HARQ_processes_soft_combining). After receiving such configuration, the UE may determine that HARQ processes 1 to N1_HARQ_processes_soft_combining should corresponds to the first HARQ process pool and HARQ processes N1_HARQ_processes_soft_combining+1 to N_HARQ_processes corresponds to the second HARQ process pool. The value of N1_HARQ_processes_soft_combining may be either signalled by the UE or may be evaluated by scaling of soft buffer as described above.

In some implementations, for the second HARQ process pool, the re-transmission with the same NDI (e.g., no toggling of the NDI) may be allowed to achieve lower block error rate (BLER). The re-transmissions may be performed by using different resource allocation and/or modulation and coding scheme (MCS). The restriction on the TBS to be the same in the re-transmissions may be removed for the HARQ processes in the second HARQ

process pool. The network node scheduler may re-transmit one or several media access control (MAC) protocol data units (PDUs) from one or several radio link control (RLC) packets in a larger TBS mapped to one HARQ process ID in the second HARQ process pool. This may be used to overcome shortage of HARQ process IDs. In addition, the differentiation between HARQ process pools may be made visible at the RLC layer or the MAC layer to ensure that each RLC service data unit (SDU) is only transmitted using one pool for the corresponding MAC PDU.

### Illustrative Implementations

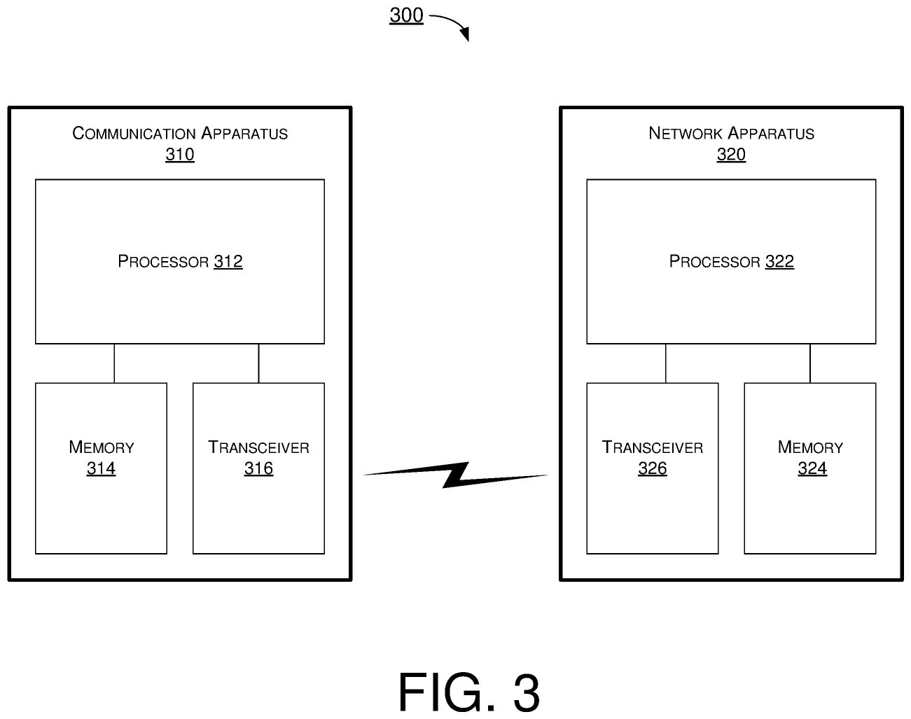

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to HARQ design in NTN communications with respect to user equipment and network apparatus in wireless communications, including scenarios/schemes described above as well as processes 400 and 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT, NB-IoT or IIoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may be configured to determine a maximum number of HARQ processes it can support. Processor 312 may determine the maximum number of HARQ processes supported under the condition of using the same soft buffer as NR-TN without increasing the soft buffer. The maximum number of HARQ processes may comprise at least one of the HARQ processes processor 312 can support with soft combining and the HARQ processes processor 312 can support without soft combining.

Processor 312 may be configured to transmit, via transceiver 316, a capability report to indicate the maximum number of HARQ processes to network apparatus 320. Then, processor 312 may perform, via transceiver 316, HARQ process transmissions based on the maximum number of HARQ processes.

In some implementations, processor 312 may explicitly signalling the maximum number of HARQ process supported the network apparatus 320. For example, processor 312 may transmit, via transceiver 316, the capability report associated with at least one of a maximum number of RB, a maximum number of spatial layers, and a maximum number of TBS. Alternatively, processor 312 may implicitly signal its capability in the capability report such as at least one of an unlimited number of HARQ processes, a specified maximum number of HARQ processes, and no increase in the maximum number of HARQ processes at all with respect to NR-TN.

In some implementations, processor 322 may be configured to receive, via transceiver 326, the capability report from communication apparatus 310. Processor 322 may determine the maximum number of HARQ processes that communication apparatus 310 can support according to the capability report. For example, processor 322 may determine the maximum number of HARQ processes according to the explicitly signalling of maximum number of HARQ process supported by communication apparatus 310. Processor 322 may also determine the maximum number of HARQ processes according to at least one of a maximum number of RB, a maximum number of spatial layers, and a maximum number of TBS. Processor 322 may further determine the maximum number of HARQ processes according to at least one of an unlimited number of HARQ processes, a specified maximum number of HARQ processes, and no increase in the maximum number of HARQ processes at all with respect to NR-TN signaled from communication apparatus 310. Then, processor 322 may perform HARQ process transmissions based on the maximum number of HARQ processes.

In some implementations, processor 322 may assume that communication apparatus 310 can support any number of HARQ processes that does not increase the soft buffer size beyond NR-TN. Processor 322 may also determine the maximum number of HARQ process that communication apparatus 310 can support according to some scaling factors. For example, processor 322 may derive the maximum number of HARQ process according to a formula of floor (16×(maximum number of RB NR-TN)/(maximum number of RB NTN)×(maximum number of layers NR-TN)/(maximum number of layers NTN)). In another example, processor 322 may derive the maximum number of HARQ process according to the scaling for number carrier components that can be supported for NR-TN/NTN. Processor 322 may also derive the maximum number of HARQ process according to other scaling such as the one corresponding to the modulation and/or coding rate.

In some implementations, processor 322 may determine the maximum number of HARQ processes according to a ratio of a maximum number of RB in NR-TN to a maximum number of RB in NR-NTN. Processor 322 may determine the maximum number of HARQ processes according to a ratio of a maximum number of spatial layers in NR-TN to a maximum number of spatial layers in NR-NTN. Processor 322 may determine the maximum number of HARQ processes according to a scaling of number of carrier components that can be supported in NR-TN and NR-NTN. Processor 322 may determine the maximum number of HARQ processes according to a scaling of modulation and coding rate used in NR-TN and NR-NTN.

In some implementations, processor 312 may signal whether it supports the scaling of the number of HARQ processes along with details on how to do the scaling. Processor 312 may be configured to transmit, via transceiver 316, an indication to indicate whether a scaling of maximum number of HARQ processes is supported. Processor 312 may the indication in the capability report.

In some implementations, processor 312 may determine the number of HARQ processes for NR-NTN without increasing the soft buffer size requirement beyond the NR-TN soft buffer size.

In some implementations, processor 312 and/or processor 322 may be configured to determine the number of DCI bits used for signalling HARQ ID (e.g., uplink or downlink) by a formula of Number_bits=max (4, ceiling (log₂ (number of HARQ processes configured on the link))), where the link may be either downlink or uplink. Processor 312 and/or processor 322 may determine the number of DCI bits used to signal the HARQ process ID according to the maximum number of HARQ processes supported.

In some implementations, processor 322 may configure communication apparatus 310 with a number of HARQ processes more than what communication apparatus 310 can perform soft combining for. Processor 312 may be able to support two kinds of HARQ processes pools. Processor 322 may configure a first HARQ process pool and a second HARQ process pool to processor 312. Processor 312 may be configured to determine the first HARQ process pool and the second HARQ process pool. Then, processor 312 and/or processor 322 may perform the HARQ process transmissions with soft combining with respect to the first HARQ process pool and perform the HARQ process transmissions without soft combining with respect to the second HARQ process pool. Accordingly, processor 312 may need to meet the HARQ soft combining performance only for the first HARQ process pool. Processor 312 may store past soft combined data to perform soft combining with future receptions only for the first HARQ process pool. This is not required for the second HARQ process pool. Processor 312 may still send ACK/NACK report but it is not required to meet the soft combining performance for the second HARQ process pool.

In some implementations, processor 322 may be restricted to transmit, via transceiver 326, a specific redundancy version of downlink data to communication apparatus 310 with respect to the second HARQ process pool. Processor 312 may expect to receive, via transceiver 316, a specific redundancy version of downlink data with respect to the second HARQ process pool and decode the downlink data based on the specific redundancy version. In addition, processor 322 may still use the NDI for the second HARQ process pool to differentiate between an initial transmission and a retransmission.

In some implementations, processor 322 may transmit, via transceiver 326, an explicit signalling to communication apparatus 310 to differentiate the first HARQ process pool and the second HARQ process pool. Processor 312 may receive, via transceiver 316, the indication to differentiate the first HARQ process pool and the second HARQ process pool. Alternatively, processor 312 and/or processor 322 may use an implicit signalling to differentiate the first HARQ process pool and the second HARQ process pool. Processor 322 may configure a number of HARQ processes which is greater than the maximum number of HARQ processes that processor 312 can support with soft combining.

### Illustrative Processes

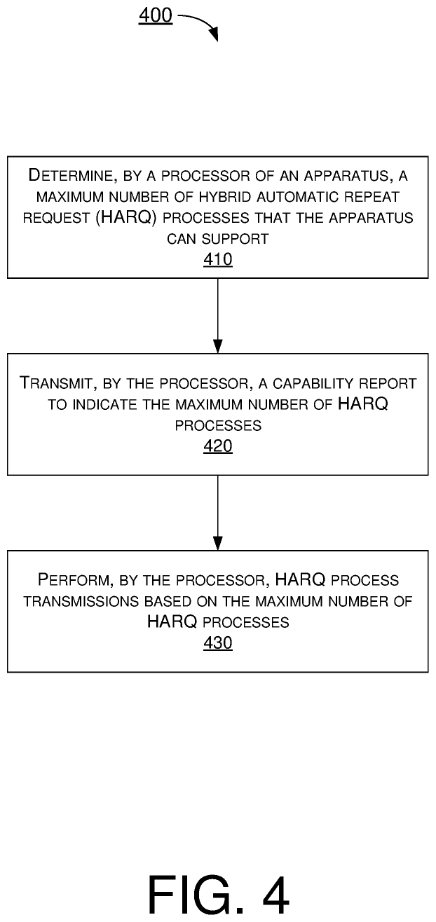

FIG. 4 illustrates an example process 400 in accordance with an implementation of the present disclosure. Process 400 may be an example implementation of above scenarios/schemes, whether partially or completely, with respect to HARQ design in NTN communications with the present disclosure. Process 400 may represent an aspect of implementation of features of communication apparatus 310. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of apparatus 310 determining a maximum number of HARQ processes that the apparatus can support. Process 400 may proceed from 410 to 420.

At 420, process 400 may involve processor 312 transmitting a capability report to indicate the maximum number of HARQ processes. Process 400 may proceed from 420 to 430.

At 430, process 400 may involve processor 312 performing HARQ process transmissions based on the maximum number of HARQ processes.

In some implementations, process 400 may involve processor 312 transmitting the capability report to a network node of an NTN.

In some implementations, the maximum number of HARQ processes may comprise at least one of a maximum number of HARQ processes with soft combining and a maximum number of HARQ processes without soft combining.

In some implementations, the capability report may comprise at least one of a maximum number of resource block, a maximum number of spatial layers, and a maximum number of transport block size.

In some implementations, the capability report may comprise at least one of an unlimited number of HARQ processes, a specified maximum number of HARQ processes, and no increase in the maximum number of HARQ processes.

In some implementations, the capability report may comprise an indication of whether a scaling of maximum number of HARQ processes is supported.

In some implementations, a soft buffer size of the apparatus is not increased.

In some implementations, process 400 may involve processor 312 determining a first HARQ process pool and a second HARQ process pool. Process 400 may further involve processor 312 performing the HARQ process transmissions with soft combining with respect to the first HARQ process pool and performing the HARQ process transmissions without soft combining with respect to the second HARQ process pool.

In some implementations, process 400 may involve processor 312 receiving a specific redundancy version of downlink data with respect to the second HARQ process pool. Process 400 may further involve processor 312 decoding the downlink data. The specific redundancy version may be self-decodable.

In some implementations, process 400 may involve processor 312 receiving an indication to differentiate the first HARQ process pool and the second HARQ process pool.

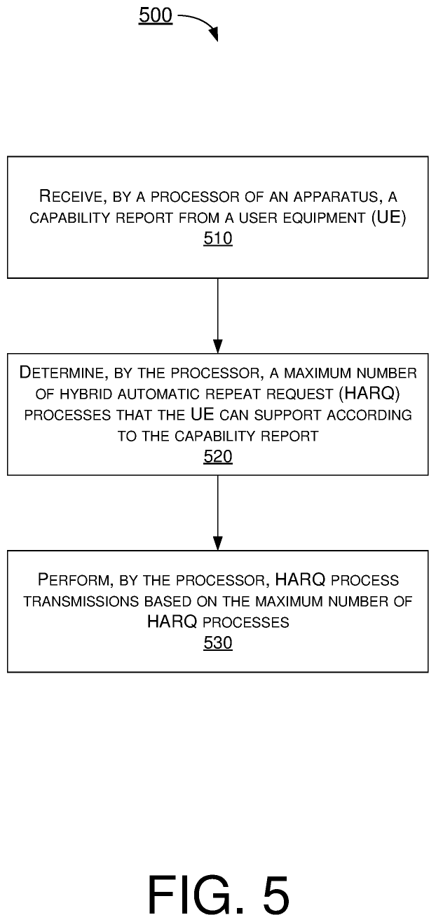

FIG. 5 illustrates an example process 500 in accordance with an implementation of the present disclosure. Process 500 may be an example implementation of above scenarios/schemes, whether partially or completely, with respect to HARQ design in NTN communications with the present disclosure. Process 500 may represent an aspect of implementation of features of network apparatus 320. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by network apparatus 320 or any suitable network nodes or network elements. Solely for illustrative purposes and without limitation, process 500 is described below in the context of network apparatus 320. Process 500 may begin at block 510.

At 510, process 500 may involve processor 322 of apparatus 320 receiving a capability report from a UE. Process 500 may proceed from 510 to 520.

At 520, process 500 may involve processor 322 determining a maximum number of HARQ processes that the UE can support according to the capability report. Process 500 may proceed from 520 to 530.

At 530, process 500 may involve processor 322 performing HARQ process transmissions based on the maximum number of HARQ processes.

In some implementations, process 500 may involve processor 322 determining the maximum number of HARQ processes according to a ratio of a maximum number of RB in NR-TN to a maximum number of RB in NR-NTN.

In some implementations, process 500 may involve processor 322 determining the maximum number of HARQ processes according to a ratio of a maximum number of spatial layers in NR-TN to a maximum number of spatial layers in NR-NTN.

In some implementations, process 500 may involve processor 322 determining the maximum number of HARQ processes according to a scaling of number of carrier components that can be supported in NR-TN and NR-NTN.

In some implementations, process 500 may involve processor 322 determining the maximum number of HARQ processes according to a scaling of modulation and coding rate used in NR-TN and NR-NTN.

In some implementations, process 500 may involve processor 322 determining a number of DCI bits used to signal a HARQ process identification according to the maximum number of HARQ processes.

In some implementations, process 500 may involve processor 322 configuring a first HARQ process pool and a second HARQ process pool to the UE. Process 500 may further involve processor 322 performing the HARQ process transmissions with soft combining with respect to the first HARQ process pool and performing the HARQ process transmissions without soft combining with respect to the second HARQ process pool.

In some implementations, process 500 may involve processor 322 transmitting a specific redundancy version of downlink data to the UE with respect to the second HARQ process pool.

In some implementations, process 500 may involve processor 322 transmitting an indication to the UE to differentiate the first HARQ process pool and the second HARQ process pool.

In some implementations, process 500 may involve processor 322 configuring a number of HARQ processes which is greater than the maximum number of HARQ processes that the UE can support with soft combining.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a maximum number of hybrid automatic repeat request (HARQ) processes that the apparatus can support;
transmitting, by the processor, a capability report to indicate the maximum number of HARQ processes; and
performing, by the processor, HARQ process transmissions based on the maximum number of HARQ processes.

2. The method of claim 1, wherein the transmitting comprises transmitting the capability report to a network node of a non-terrestrial network (NTN).

3. The method of claim 1, wherein the maximum number of HARQ processes comprises at least one of a maximum number of HARQ processes with soft combining and a maximum number of HARQ processes without soft combining.

4. The method of claim 1, wherein the capability report comprises at least one of a maximum number of resource block, a maximum number of spatial layers, and a maximum number of transport block size.

5. The method of claim 1, wherein the capability report comprises at least one of an unlimited number of HARQ processes, a specified maximum number of HARQ processes, and no increase in the maximum number of HARQ processes.

6. The method of claim 1, wherein the capability report comprises an indication of whether a scaling of maximum number of HARQ processes is supported.

7. The method of claim 1, wherein a soft buffer size of the apparatus is not increased.

8. The method of claim 1, further comprising:
determining, by the processor, a first HARQ process pool and a second HARQ process pool;
performing, by the processor, the HARQ process transmissions with soft combining with respect to the first HARQ process pool; and
performing, by the processor, the HARQ process transmissions without soft combining with respect to the second HARQ process pool.

9. The method of claim 8, further comprising:
receiving, by the processor, a specific redundancy version of downlink data with respect to the second HARQ process pool; and
decoding, by the processor, the downlink data,
wherein the specific redundancy version is self-decodable.

10. The method of claim 8, further comprising:
receiving, by the processor, an indication to differentiate the first HARQ process pool and the second HARQ process pool.

11. A method, comprising:
receiving, by a processor of an apparatus, a capability report from a user equipment (UE);
determining, by the processor, a maximum number of hybrid automatic repeat request (HARQ) processes that the UE can support according to the capability report; and
performing, by the processor, HARQ process transmissions based on the maximum number of HARQ processes.

12. The method of claim 11, further comprising:
determining, by the processor, the maximum number of HARQ processes according to a ratio of a maximum number of resource block (RB) in new radio-terrestrial network (NR-TN) to a maximum number of RB in NR-non-terrestrial network (NR-NTN).

13. The method of claim 11, further comprising:
determining, by the processor, the maximum number of HARQ processes according to a ratio of a maximum number of spatial layers in new radio-terrestrial network (NR-TN) to a maximum number of spatial layers in NR-non-terrestrial network (NR-NTN).

14. The method of claim 11, further comprising:
determining, by the processor, the maximum number of HARQ processes according to a scaling of number of carrier components that can be supported in new radio-terrestrial network (NR-TN) and NR-non-terrestrial network (NR-NTN).

15. The method of claim 11, further comprising:
determining, by the processor, the maximum number of HARQ processes according to a scaling of modulation and coding rate used in new radio-terrestrial network (NR-TN) and NR-non-terrestrial network (NR-NTN).

16. The method of claim 11, further comprising:
determining, by the processor, a number of downlink control information (DCI) bits used to signal a HARQ process identification according to the maximum number of HARQ processes.

17. The method of claim 11, further comprising:
configuring, by the processor, a first HARQ process pool and a second HARQ process pool to the UE;
performing, by the processor, the HARQ process transmissions with soft combining with respect to the first HARQ process pool; and
performing, by the processor, the HARQ process transmissions without soft combining with respect to the second HARQ process pool.

18. The method of claim 17, further comprising:
transmitting, by the processor, a specific redundancy version of downlink data to the UE with respect to the second HARQ process pool,
wherein the specific redundancy version is self-decodable.

19. The method of claim 17, further comprising:
transmitting, by the processor, an indication to the UE to differentiate the first HARQ process pool and the second HARQ process pool.

20. The method of claim 11, further comprising:
configuring, by the processor, a number of HARQ processes which is greater than the maximum number of HARQ processes that the UE can support with soft combining.
